(19) United States
(12) Patent Application Publication
(10) Pub. No.: US 2024/0071285 A1
(43) Pub. Date: Feb. 29, 2024

(54) MULTI-DIRECTIONAL EXPANDABLE DISPLAYS

(71) Applicant: HEWLETT-PACKARD DEVELOPMENT COMPANY, L.P., Spring, TX (US)

(72) Inventors: Hsing-Hung HSIEH, Taipei City (TW); Super LIAO, Taipei City (TW); Kuan-Ting WU, Taipei City (TW)

(21) Appl. No.: 17/899,302

(22) Filed: Aug. 30, 2022

(51) Int. Cl. G09G 3/20; G09G 3/3233

(52) U.S. Cl. CPC G09G 3/2096; G09G 3/3233; G09G 3/035; G09G 2330/021; G09G 2360/08

(57) ABSTRACT

In examples, an electronic device comprises an expandable display having a primary portion and first and second auxiliary portions. The expandable display has a default mode in which the first and second auxiliary portions are hidden and an expanded mode in which the first and second auxiliary portions are visible on opposing horizontal ends of the primary portion. The electronic device includes first and second timing controllers (TCONs) to control pixels in the expandable display.

### BACKGROUND

Many electronic devices include expandable displays. An expandable display enables a user to dynamically increase and decrease the viewing area of the display. Such an electronic device generally includes a base member and a display composed of a flexible material, such as plastic. A primary portion of the display is in front of the base member and visible to the user, while an auxiliary portion of the display is behind the base member, hidden from the user. As a user pulls on an edge of the device, the auxiliary portion of the display is gradually translated (e.g., using a rolling pin coupled to an edge of the base member) from behind the base member to the front of the base member and becomes visible to the user. The more the user pulls on the edge of the device, the more of the auxiliary portion becomes visible to the user. Similarly, pushing on the edge of the device causes the visible areas of the auxiliary portion of the display to return behind the base member, out of user view.

### BRIEF DESCRIPTION OF THE DRAWINGS

Various examples will be described below referring to the following figures:

FIG. 1A is a frontal view of an electronic device in a default mode, in accordance with various examples.

FIG. 1B is a frontal view of an electronic device in an expanded mode, in accordance with various examples.

FIG. 2 is a block diagram of an electronic device, in accordance with various examples.

FIG. 3 is a schematic diagram of timing controllers (TCONs) coupled to pixels in primary and auxiliary portions of an expandable display, in accordance with various examples.

FIGS. 4A and 4B are circuit diagrams of pixels in primary and auxiliary portions of an expandable display, in accordance with various examples.

### DETAILED DESCRIPTION

As explained above, many electronic devices include expandable displays. An expandable display enables a user to dynamically increase and decrease the viewing area of the display. Such an electronic device generally includes a base member and a display composed of a flexible material, such as plastic. A primary portion of the display is in front of the base member and visible to the user, while an auxiliary portion of the display is behind the base member, hidden from the user. As a user pulls on an edge of the device, the auxiliary portion of the display is gradually translated (e.g., using a rolling pin coupled to an edge of the base member) from behind the base member to the front of the base member and becomes visible to the user. The more the user pulls on the edge of the device, the more of the auxiliary portion becomes visible to the user. Similarly, pushing on the edge of the device causes the visible areas of the auxiliary portion of the display to return behind the base member, out of user view.

Various structural limitations prevent expandable displays from expanding in multiple directions. For example, an expandable display of a laptop computer will expand only to the left and in no other direction, or only to the right and in no other direction, or only upward and in no other direction. Each of these expansion options diminishes the user experience because it has limited usefulness and limited user-friendliness. For example, a laptop display that expands only to the right or to the left will have asymmetry of the display with respect to the keyboard, resulting in an awkward viewing experience, challenges in navigating the physical environment of the user, weight balancing issues, and so on. Similarly, a display that expands upward may provide symmetry but retains the challenges relating to the user physical environment and presents new challenges stemming from the diminished usefulness of a screen that is significantly taller than it is wide.

This disclosure describes various examples of electronic devices having multi-directional expandable displays. An example electronic device includes a display that is expandable in multiple horizontal directions. When the expandable display is not expanded, the display is said to be in a default mode, with a primary portion of the display visible to a user. When the expandable display is expanded by any amount, the display is said to be in an expanded mode, with both the primary portion and at least some of an auxiliary portion of the display visible to the user. The electronic device also includes first and second timing controllers (TCONs) on separate printed circuit boards (PCBs) positioned on opposing top and bottom horizontal sides of the primary portion of the expandable display. The electronic device also includes a graphics processing unit (GPU) coupled to and controlling the first and second TCONs.

The first TCON, which is positioned on a first side (e.g., top or bottom) of the primary portion of the expandable display, is coupled to and controls the pixels in the primary portion of the expandable display. The second TCON, which is positioned on a second side (e.g., top or bottom) of the primary portion of the expandable display and opposite the first side, is coupled to and controls the pixels in the first and second auxiliary portions of the expandable display. Unlike expandable displays, hardware and circuitry such as TCONs are inflexible and are not retractable, and thus coupling the TCONs only to the primary portion of the expandable display enables the display to be expanded or retracted in multiple directions without difficulty. Further, because the primary and auxiliary portions of the expandable display are controllable by separate TCONs, when the expandable display is in the default mode, the TCON that controls the auxiliary portions of the expandable display may be shut off or put in a low power state to conserve power.

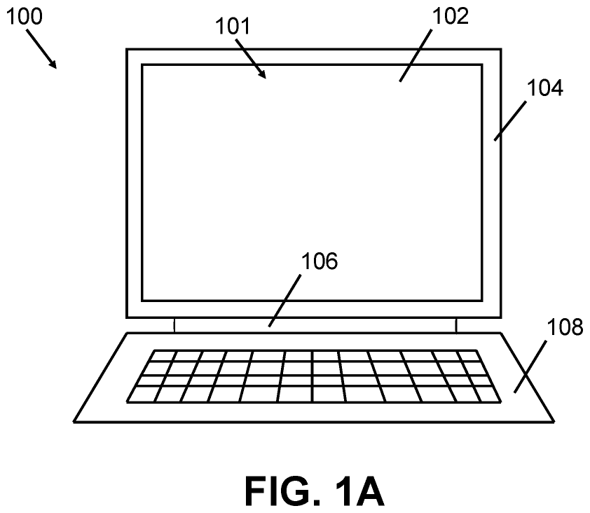

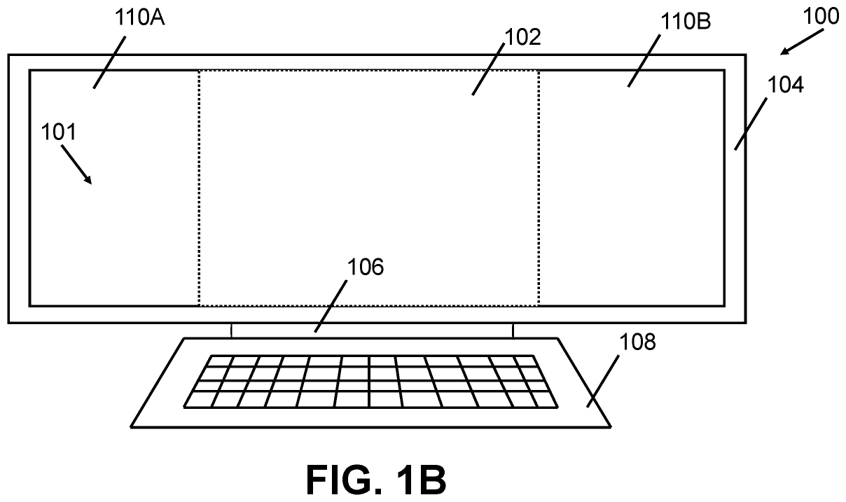

FIG. 1A is a frontal view of an electronic device 100, in accordance with various examples. Although the electronic device 100 is depicted as being a laptop computer, the electronic device 100 may include, for example, a desktop computer, a smartphone, a tablet, a television, or any other suitable electronic device having a display. The electronic device 100 includes a display 101 framed by a bezel 104. A hinge 106 rotatably couples the display 101 to a keyboard 108 or other input device. In the configuration of FIG. 1A, the display 101 is in a default mode, meaning that only the primary portion 102 is visible to a user, and any auxiliary portions of the display 101 are not visible to the user. Such auxiliary portions are hidden, for example, behind the primary portion 102. Rolling pins or other mechanisms positioned along the left and right hand ends of the display 101, in combination with the flexibility of the display 101 (e.g., a plastic, flexible display), facilitate the exposure or hiding of such auxiliary portions.

FIG. 1B is a frontal view of the electronic device 100 in an expanded mode, in accordance with various examples. More specifically, the auxiliary portions 110A and 110B of the display 101 are visible to the user in the expanded mode. In addition, the primary portion 102 (shown in dotted lines) is also visible to the user in the expanded mode. A user may expose the auxiliary portion 110A by pulling the left-hand side of the bezel 104 to the left, thereby causing the previously hidden auxiliary portion 110A to become exposed. Similarly, a user may expose the auxiliary portion 110B by pulling the right-hand size of the bezel 104 to the right, thereby causing the previously hidden auxiliary portion 110B to become exposed. The electronic device 100 may be shifted from the expanded mode to the default mode by pushing on the left- and right-hand sides of the bezel 104 to cause the auxiliary portions 110A and 110B to become hidden behind the primary portion 102. As described in greater detail below, the display 101 is able to expand in multiple directions (to the left and to the right) as shown in FIG. 1B because of the positions of timing controllers (TCONs) in the electronic device 100 and the manner in which the TCONs are coupled to pixels in the primary portion 102 and the auxiliary portions 110A and 110B.

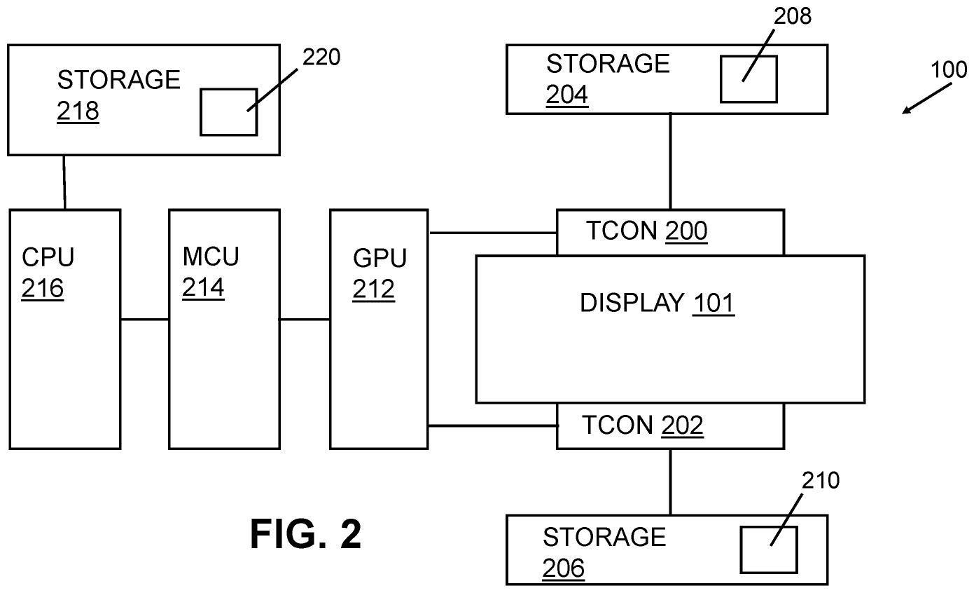

FIG. 2 is a block diagram of the electronic device 100, in accordance with various examples. The electronic device 100 includes the display 101. A TCON 200 is positioned along a top horizontal side of the display 101. A TCON 202 is positioned along a bottom horizontal side of the display 101. In examples, the TCONs 200 and 202 are included in the bezel 104, which is not expressly shown in FIG. 2 for clarity. In other examples, the TCONs 200 and 202 are positioned behind the primary portion 102 (FIGS. 1A and 1B). In examples, the TCON 200 and 202 is composed of a flexible material and has a non-planar shape (e.g., is bent to be in two or more planes). The electronic device 100 includes storage 204 and 206 coupled to the TCON 200 and 202, respectively. The storage 204 stores executable code 208, and the storage 206 stores executable code 210. The TCON 200 executes the executable code 208 to perform the actions attributed herein to the TCON 200. The TCON 202 executes the executable code 210 to perform the actions attributed herein to the TCON 202. The storages 204, 206 may be positioned in the bezel 104, behind the primary portion 102, or in any other suitable location. The electronic device 100 also includes a graphics processing unit (GPU) 212 coupled to the TCONs 200, 202. The GPU 212 may exchange signals with and controls or sends commands to the TCONs 200, 202. A microcontroller unit (MCU) 214 couples to the GPU 212 and exchanges signals with and controls or sends commands to the GPU 212. A central processing unit (CPU) 216 couples to the MCU 214 and exchanges signals with and controls or sends commands to the MCU 214. The CPU 216 is coupled to storage 218 storing executable code 220. The CPU 216 executes the executable code 220, thereby causing the CPU 216 to perform the actions attributed herein to the CPU 216. The TCON 200, 202 are coupled to the pixels in the display 101 as described below.

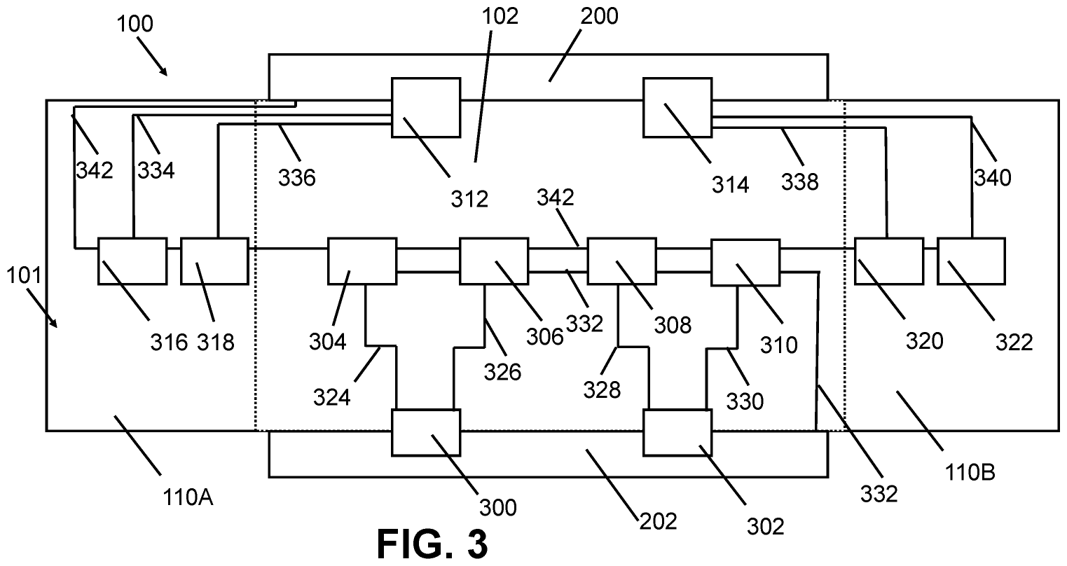

FIG. 3 is a schematic diagram of timing controllers (TCONs) 200, 202 coupled to pixels in primary and auxiliary portions of the expandable display 101, in accordance with various examples. The TCONs 200, 202 are positioned on opposing horizontal sides of the display 101, as shown. In examples, the TCONs 200, 202 are positioned on non-expandable sides of the display 101. In the example of FIG. 3, the left and right sides of the display 101 are expandable, so the TCONs 200, 202 are positioned on top and bottom sides of the display 101. If the top and bottom sides of the display 101 were expandable, the TCONs 200, 202 would be positioned on left and right sides of the display 101. In FIG. 3, the TCONs 200, 202 are positioned along the horizontal edges of the primary portion 102, but not along the edges of the auxiliary portions 110A, 1106. The TCON 202 has flexible printed circuits (FPCs) 300, 302 coupled thereto, and the TCON 200 has FPCs 312, 314 coupled thereto. In examples, any number of FPCs may be included, but each TCON 200, 202 is depicted as being coupled to two FPCs for clarity and ease of explanation. FPCs are interfaces between the TCONs 200, 202 and the pixels of the display 101. In examples, each FPC 300, 302, 312, 314 is partially coupled to a respective TCON 200, 202 and partially coupled to the display 101.

The primary portion 102 includes illustrative pixels 304, 306, 308, and 310. Additional pixels may be included in the primary portion 102 but are not expressly shown to preserve clarity and ease of explanation. The auxiliary portion 110A includes illustrative pixels 316, 318, and the auxiliary portion 1106 includes illustrative pixels 320, 322, although each of the auxiliary portions 110A, 1106 may include additional pixels as well. The TCON on one side of the primary portion 102, such as the TCON 202 in this example, couples to and controls the pixels in the primary portion 102 (e.g., the pixels 304, 306, 308, and 310), and the TCON 202 does not control the pixels in the auxiliary portions 110A, 1106 (e.g., the pixels 316, 318, 320, and 322). The TCON on an opposing side of the primary portion 102, such as the TCON 200 in this example, couples to and controls the pixels in the auxiliary portions 110A, 1106 (e.g., the pixels 316, 318, 320, and 322), and the TCON 200 does not control the pixels in the primary portion 102 (e.g., the pixels 304, 306, 308, and 310).

The TCON 202 is coupled to the pixels 304, 306, 308, and 310 by way of a gate line 332. The gate line 332 does not couple to the pixels of the auxiliary portions 110A, 1106. The gate line 332 is referred to as a “gate line” because it is a connection that couples to the gate terminals (or other suitable control terminals) of transistors (e.g., metal oxide semiconductor field effect transistors (MOSFETs)) in the pixels 304, 306, 308, and 310. Thus, signals provided on the gate line 332 control the switching action of such transistors in the pixels 304, 306, 308, and 310. The FPC 300 of the TCON 202 is coupled to the pixels 304, 306 by way of data lines 324, 326, respectively. The FPC 302 of the TCON 202 is coupled to the pixels 308, 310 by way of data lines 328, 330, respectively. Data lines, such as data lines 324, 326, 328, and 330, are referred to as “data lines” because they provide graphical data to pixels of the display 101. The data lines 324, 326, 328, and 330 do not couple to the pixels of the auxiliary portions 110A, 1106. A pixel transistor that is on in response to an appropriate gate line signal may respond to a data line signal, while a pixel transistor that is off in response to an appropriate gate line signal may not respond to a data line signal.

The TCON 200 is coupled to the pixels 316, 318, 320, and 322 by way of a gate line 342. The gate line 342 is referred to as a “gate line” because it is a connection that couples to the gate terminals (or other suitable control terminals) of transistors (e.g., MOSFETs) in the pixels 316, 318, 320, and 322. Thus, signals provided on the gate line 342 control the switching action of such transistors in the pixels 316, 318, 320, and 322. In examples, the gate line 342 extends through pixels in the primary portion 102, such as the pixels 304, 306, 308, and 310, but these pixels are not controlled by the gate line 342, nor are these pixels coupled to the gate line 342. The FPC 312 of the TCON 200 is coupled to the pixels 316, 318 by way of data lines 334, 336, respectively. The FPC 314 of the TCON 200 is coupled to the pixels 320, 322 by way of data lines 338, 340, respectively. The data lines 334, 336, 338, and 340 do not couple to pixels in the primary portion 102. Data lines, such as data lines 334, 336, 338, and 340, are referred to as “data lines” because they provide graphical data to pixels of the display 101. A pixel transistor that is on in response to an appropriate gate line signal may respond to a data line signal, while a pixel transistor that is off in response to an appropriate gate line signal may not respond to a data line signal.

Alternative configurations besides that shown in FIG. 3 are contemplated and included in the scope of this disclosure. For example, the primary portion 102 and the auxiliary portions 110A, 1106 may include multiple rows and columns of pixels, and the TCON and FPCs that control such pixels may be coupled to such pixels accordingly. Multiple additional gate lines and/or data lines may be included as appropriate in the electronic device 100. Regardless of the precise configuration of TCONs, FPCs, pixels, data lines, and gate lines, however, the TCONs are positioned on opposing horizontal sides of the primary portion 102, with one of these TCONs coupled to and controlling pixels in the primary portion 102, and with the other of these TCONs coupled to and controlling pixels in the auxiliary portions 110A, 1106. In this way, when the electronic device 100 is in a default mode (e.g., the auxiliary portions 110A, 1106 are hidden), the TCON 200 that controls the pixels in the auxiliary portions 110A, 1106 is in a power saving mode (e.g., is turned off, or is in a hibernation or sleep mode). Furthermore, because the TCONs 200, 202 are located on opposing sides of the primary portion 102 and do not obstruct the left or right sides of the display 101, the display 101 can expand and retract on both its left and right sides, in contrast to other expandable display solutions in which the display can be expanded and retracted only on one side.

In examples, the gate line 342 and the data lines 334, 336, 338, and 340 are flexible such that they remain appropriately connected to their respective pixels in the auxiliary portions 110A, 1106 irrespective of whether the display 101 is in an expanded mode (e.g., the auxiliary portions 110A, 110B are exposed) or a default mode (e.g., the auxiliary portions 110A, 110B are hidden). In examples, the gate line 332 and the data lines 324, 326, 328, and 330 may be flexible or rigid, as such lines are positioned in the primary portion 102, which remains visible irrespective of whether the electronic device 100 is in the default mode or the expanded mode.

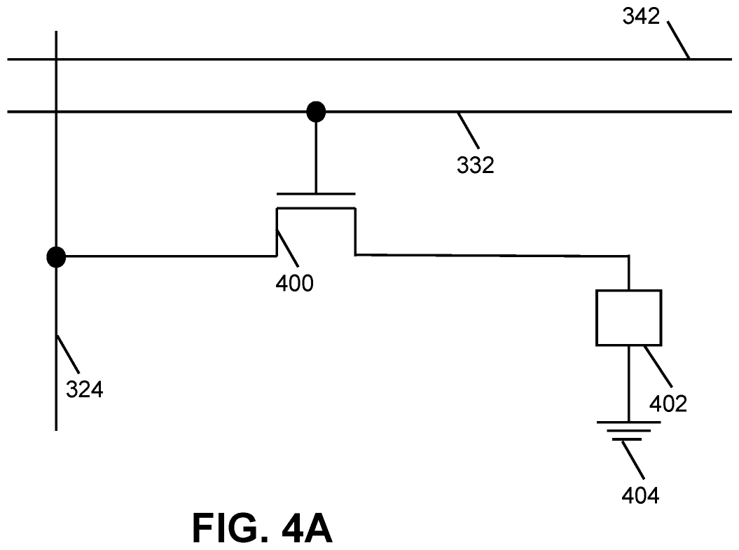

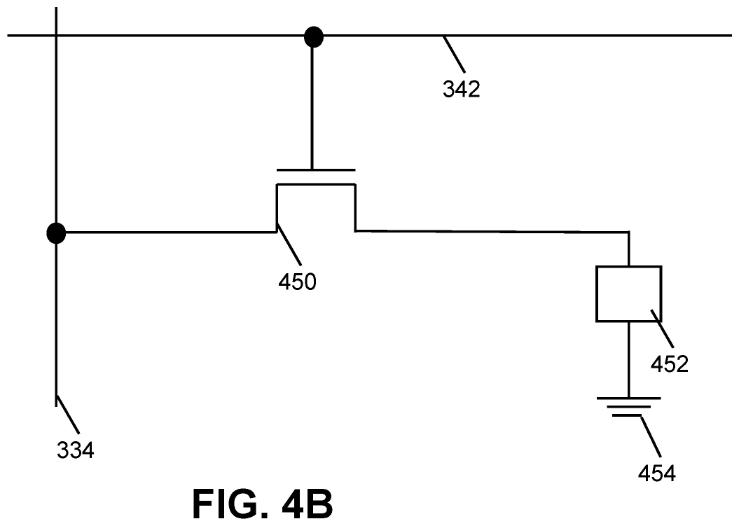

FIGS. 4A and 4B are circuit diagrams of pixels in the primary portion 102 and the auxiliary portions 110A, 110B of the expandable display 101, in accordance with various examples. More specifically, FIGS. 4A and 4B show an example manner in which the data and gate lines of the display 101 couple to the pixels of the display 101. In FIG. 4A, a pixel in the primary portion 102 includes a transistor 400 (e.g., a MOSFET), a light emission control device 402 (e.g., which may include, for example, organic light emitting diode (OLED), liquid crystal display (LCD), electronic paper display (EPD)) coupled to the MOSFET, and ground 404 coupled to the light emission control device 402. The gate terminal of the transistor 400 is coupled to the gate line 332, and the switching action of the transistor 400 is determined by the signal provided on the gate line 332. A non-gate terminal of the transistor 400 (e.g., the drain or source of the transistor 400) is coupled to the data line 324. When the transistor 400 is off, the signal provided on the data line 324 is not used by the transistor 400. When the transistor 400 is on, the signal provided on the data line 324 is provided to the light emission control device 402, thereby affecting the behavior of the pixel. FIG. 4B is an example of a pixel in the auxiliary portions 110A, 110B. The pixel includes a transistor 450 (e.g., a MOSFET) coupled to a light emission control device 452, which, in turn, is coupled to ground 454. The gate terminal of the transistor 450 is coupled to the gate line 342, and a non-gate terminal (e.g., source or drain) of the transistor 450 is coupled to the data line 334. The operation of the pixel in FIG. 4B is the same as that of FIG. 4A and thus is not repeated here.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

As used herein, the term “display” refers to an electronic display (e.g., a liquid crystal display (LCD), a plasma display, etc.) that is to display images generated by an associated computing device. The terms “flexible display” or “expandable display” refer to an electronic display that may be deformed (e.g., rolled, folded, etc.) within a given parameter or specification (e.g., a minimum radius of curvature) without losing electrical function or connectivity.

What is claimed is:

1. An electronic device, comprising:
an expandable display having a primary portion and first and second auxiliary portions, the expandable display having a default mode in which the first and second auxiliary portions are hidden and an expanded mode in which the first and second auxiliary portions are visible on opposing horizontal ends of the primary portion; and
first and second timing controllers (TCONs) to control pixels in the expandable display.

2. The electronic device of claim 1, wherein the first and second TCONs are positioned on opposing, horizontal ends of the primary portion.

3. The electronic device of claim 1, wherein the first TCON is to control pixels in the primary portion and not pixels in the first and second auxiliary portions.

4. The electronic device of claim 3, wherein the first TCON is coupled to a gate line, the gate line coupled to the pixels in the primary portion and not to the pixels in the first and second auxiliary portions.

5. The electronic device of claim 4, wherein the first TCON is coupled to a set of data lines, the data lines in the set coupled to the pixels in the primary portion and not to the pixels in the first and second auxiliary portions.

6. The electronic device of claim 1, wherein the second TCON is to control pixels in the first and second auxiliary portions and not pixels in the primary portion.

7. The electronic device of claim 6, wherein the second TCON is coupled to a gate line, the gate line coupled to the pixels in the first and second auxiliary portions and not the pixels in the primary portion.

8. The electronic device of claim 7, wherein the second TCON is coupled to a set of data lines, the data lines in the set coupled to the pixels in the first and second auxiliary portions and not to the pixels in the primary portion.

9. The electronic device of claim 1, wherein the second TCON is to enter a power saving mode in response to the expandable display being in the default mode.

10. An electronic device, comprising:
an expandable display having a primary portion and first and second auxiliary portions, the display adjustable in multiple horizontal directions to reveal and hide the first and second auxiliary portions;
a first timing controller (TCON) positioned on a first horizontal side of the primary portion, the first TCON coupled to control terminals of pixels in the primary portion of the expandable display; and
a second TCON positioned on a second horizontal side of the primary portion opposite from the first horizontal side, the second TCON coupled to control terminals of pixels in the first and second auxiliary portions of the expandable display.

11. The electronic device of claim 10, wherein the first TCON is coupled to a gate line, the gate line coupled to gate terminals of transistors in the pixels of the primary portion.

12. The electronic device of claim 11, wherein the first TCON is coupled to a set of data lines, the data lines in the set coupled to non-gate terminals of the transistors in the pixels of the primary portion.

13. The electronic device of claim 10, wherein the first TCON is not coupled to control terminals of pixels in the first and second auxiliary portions.

14. The electronic device of claim 10, wherein the second TCON is coupled to a gate line, the gate line coupled to gate terminals of transistors in the pixels of the first and second auxiliary portions.

15. The electronic device of claim 14, wherein the second TCON is coupled to a set of data lines, the data lines in the set coupled to non-gate terminals of the transistors in the pixels of the first and second auxiliary portions.

16. The electronic device of claim 10, wherein the second TCON is not coupled to control terminals of pixels in the primary portion.

17. The electronic device of claim 10, wherein the second TCON is to enter a power saving mode in response to the first and second auxiliary portions being hidden.

18. An electronic device, comprising:
an expandable display having a primary portion and first and second auxiliary portions, the display adjustable in a first horizontal direction to reveal and hide the first auxiliary portion and in a second horizontal direction to reveal and hide the second auxiliary portion;
a first timing controller (TCON) positioned on a first horizontal side of the primary portion and coupled to gate lines and data lines of pixels in the primary portion of the expandable display; and
a second TCON positioned on a second horizontal side of the primary portion opposite from the first horizontal side, the second TCON coupled to gate lines and data lines of pixels in the first and second auxiliary portions of the expandable display.

19. The electronic device of claim 18, wherein the first TCON is not coupled to the pixels in the first and second auxiliary portions, and wherein the second TCON is not coupled to the pixels in the primary portion.

20. The electronic device of claim 18, wherein the second TCON is to enter a power saving mode in response to the first and second auxiliary portions being hidden.
